(19) United States
(12) Patent Application Publication
(10) Pub. No.: US 2009/0091644 A1
(43) Pub. Date: Apr. 9, 2009

(54) Metallic nanostructure color filter array and method of making the same

(76) Inventor: Jeffrey L. Mackey, Boise, ID (US)

Correspondence Address: DICKSTEIN SHAPIRO LLP, 1825 EYE STREET NW, Washington, DC, 20006-5403, US

(21) Appl. No.: 11/905,952

(22) Filed: Oct. 5, 2007

(51) Int. Cl. H04N 5/335

(52) U.S. Cl. 348/273; 348/E09.01

(57) ABSTRACT

A color filter array with metallic nanostructures and a method of fabricating the same. The color filter array is fabricated by forming a plurality of color filter regions corresponding to pixels of a pixel array, the color filter regions being formed of metallic nanostructures having different optical properties and being arranged in a color filter pattern.

### FIELD OF THE INVENTION

Disclosed embodiments relate generally to color filter arrays and methods for making color filter arrays.

### BACKGROUND

Solid-state image sensors, also known as imagers, absorb incident radiation of a particular wavelength (such as optical photons, x-rays, or the like) and generate an electrical signal corresponding to the absorbed radiation. There are a number of different types of semiconductor-based imagers, including charge coupled devices (CCDs), photodiode arrays, charge injection devices (CIDs), hybrid focal plan arrays, and CMOS imagers. Current applications of solid-state imagers include cameras, cellular phones, scanners, computers, machine vision systems, vehicle navigation systems, star trackers, and motion detector systems, among other uses.

These imagers typically consist of an array of pixels containing photosensors, where each pixel produces a signal corresponding to the intensity of light impinging on its photosensor when an image is focused on the array. These signals may then be stored, for example, for later display, printing, or analysis or are otherwise used to provide information about the optical image. The photosensors are typically phototransistors, photogates, or photodiodes. The magnitude of the signal produced by each pixel, therefore, is proportional to the amount of light impinging on the photosensor.

To allow the photosensors to capture a color image, the photosensors must be able to separately detect photons traveling at different wavelengths. Accordingly, each pixel should be sensitive only to one color or spectral band. For this, a color filter array (CFA) is typically placed in front of the pixel array so that each pixel measures the light of the color of its associated filter. Thus, typically each pixel of a color imager is covered with either a red, green, or blue filter, according to a specific pattern, although other colored filters may also be used.

Color filter arrays are commonly arranged in a mosaic sequential pattern of red, green, and blue filters known as a Bayer filter pattern. The Bayer filter pattern is quartet-ordered with successive rows that alternate red and green filters, then green and blue filters. Thus, each red filter is surrounded by four green and four blue filters and each blue filter is surrounded by four red and four green filters. In contrast, each green filter is surrounded by two red, four green, and two blue filters. The heavy emphasis placed upon green filters is due to human visual response, which reaches a maximum sensitivity in the 550-nanometer (green) wavelength region of the visible spectrum.

As shown in FIG. 1, the Bayer pattern 15 is an array of repeating red (R), green (G), and blue (B) filters. Half of the filters in the Bayer pattern 15 are green (G), while one quarter are red (R) and the other quarter are blue (B). As shown, the pattern 15 repeats a row of alternating red (R) and green (G) color filters followed by a row of alternating blue (B) and green (G) filters. The Bayer patterned filters (or other patterns) may be deposited on top of an array of pixel sensor cells.

Some examples of color filter arrays are disclosed in U.S. Pat. Nos. 6,429,036; and 7,202,894, and in U.S. Publication Nos. 2004/0234873; 2007/0001094; 2007/0030379; 2007/0034884; and 2007/0042278, each assigned to Micron Technology Inc.

An existing class of color filter arrays are fabricated using evaporated colorants. Typically, such color filter arrays are fabricated using the following process: a negative photoresist containing a colorant, for example, a transition-metal based pigment, is deposited on a semiconductor substrate; and the pigmented photoresist is patterned, leaving the color pigment over the pixels. The Bayer pattern requires the printing and patterning of three negative resist layers on a passivation layer, each of a respective color.

Some examples of color filter arrays formed using color pigments are disclosed in U.S. Pat. No. 6,783,900, and in U.S. Publication No. 2004/0246351, each assigned to Micron Technology Inc.

Color filter arrays formed using colorants, however, can have several drawbacks. First, the absorption spectra of colorants is diffuse and slowly varying, which can result in poor spectral details. Secondly, differences in material properties of the materials used for the three primary color formulations result in variations in color responses.

Accordingly, a color filter array that more effectively and accurately defines the color filter array colors, provides control of the absorption spectrum, and facilitates improved color separation would be advantageous, as would a method of fabricating such a color filter array.

### BRIEF DESCRIPTION OF THE DRAWINGS

FIG. 1 is a diagram showing a known Bayer mosaic filter pattern.

FIG. 2A is a schematic diagram of a metallic nanoshell at an initial stage of fabrication.

FIG. 2B is a schematic diagram of a metallic nanoshell during a stage of fabrication subsequent to that shown in FIG. 2A.

FIG. 3A is a cross-sectional view of a first embodiment described herein depicting a color pixel and filter structure at an initial stage of processing.

FIG. 3B is a cross-sectional view of the first embodiment during a stage of fabrication subsequent to that shown in FIG. 3A.

FIG. 3C is a cross-sectional view of the first embodiment during a stage of fabrication subsequent to that shown in FIG. 3B.

FIG. 3D is a cross-sectional view of the first embodiment during a stage of fabrication subsequent to that shown in FIG. 3C.

FIG. 3E is a cross-sectional view of the first embodiment during a stage of fabrication subsequent to that shown in FIG. 3D.

FIG. 3F is a cross-sectional view of the first embodiment during a stage of fabrication subsequent to that shown in FIG. 3E.

FIG. 3G is a cross-sectional view of the first embodiment during a stage of fabrication subsequent to that shown in FIG. 3F.

FIG. 3H is a cross-sectional view of the first embodiment during a stage of fabrication subsequent to that shown in FIG. 3G.

FIG. 3I is a top view of the first embodiment during a stage of fabrication subsequent to that shown in FIG. 3H.

FIG. 3J is a cross-sectional view of a second embodiment described herein depicting a color pixel and filter structure.

FIG. 4 is an illustration of an imager containing embodiments discussed herein.

FIG. 5 is a block diagram illustrating a camera containing embodiments discussed herein.

FIG. 6 is a block diagram illustrating a cell phone containing embodiments discussed herein.

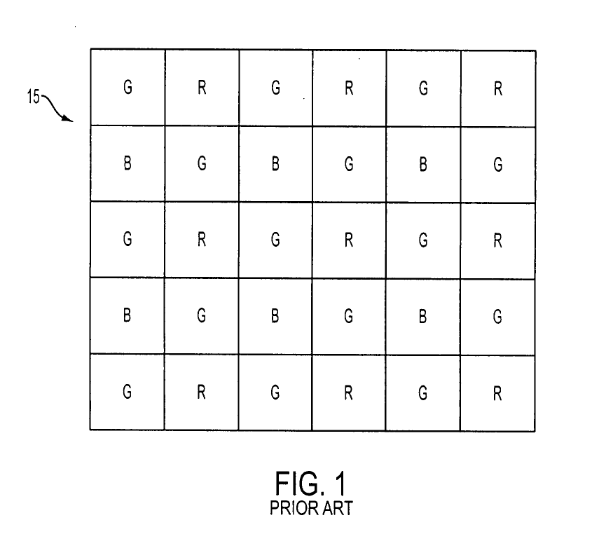

### DETAILED DESCRIPTION

The terms “wafer” and “substrate,” as used herein, are to be understood as including silicon, silicon-on-insulator (SOI) or silicon-on-sapphire (SOS) technology, doped and undoped semiconductors, epitaxial layers of silicon supported by a base semiconductor foundation, and other semiconductor structures. Furthermore, when reference is made to a “wafer” or “substrate” in the following description, previous processing steps may have been utilized to form regions, junctions, or material layers in or over the base semiconductor structure or foundation. In addition, the semiconductor need not be silicon-based, but could be based on silicon-germanium, germanium, gallium arsenide or other semiconductors. Furthermore, it is possible that the substrate is made of materials other than semiconductor-based materials.

The term “pixel,” as used herein, refers to a photo-element unit cell containing a photosensor device and associated structures for converting photons to an electrical signal. For purposes of illustration, a representative three-color R, G, B pixel array is described herein; however, the invention is not limited to the use of an R, G, B array, and can be used with other color arrays, such as a C, M, Y, G (which represents cyan, magenta, yellow and green color filters) array, a single color filter array, or for pixel arrays for filtering and detecting non-visible spectra photo emissions. For purposes of illustration, a portion of a pixel array having pixels of two different colors and its manner of formation is shown in the figures and description herein; however, typically fabrication of a plurality of like pixels proceeds simultaneously. For purposes of this disclosure, however, pixels of a pixel array may be referred to by color (i.e., “red pixel,” “blue pixel,” etc.) when a color filter is used in connection with the pixel to pass through a particular wavelength of light, corresponding to a particular color, onto the pixel. Accordingly, the following detailed description is not to be taken in a limiting sense.

For purposes of this disclosure, “filter” and “pass filter” may be used interchangeably. For example, a “blue-pass filter” refers to a color filter used in connection with a pixel to pass through blue light onto the pixel. Similarly, a “red-pass filter” and a “green-pass filter” refer to color filters used in connection with pixels to pass through red and green light, respectively, onto the pixels.

Disclosed embodiments, here, relate to a metallic nanostructure color filter array and a method of making the same. By changing the geometric parameters of the metallic nanostructures such as size and shape, the absorption spectrum of these metallic nanostructure color filter arrays can be better controlled, to meet the needs of an individual user.

The term “nanostructure(s),” as used herein, refers to structures which have a size between molecular and micron-sized structures. Typically, such structures have at least one dimension on the nanoscale, e.g., between about 1 nm and about 100 nm. The nanostructures can be configured so as to include one or more of the following: (1) a nano surface having one dimension on the nanoscale, for example, a surface thickness between 1 nm and 100 nm; (2) a nanotube having two dimensions on the nanoscale, for example, a diameter and length each between 1 nm and 100 mm; and (3) a nanoparticle having three dimensions on the nanoscale, for example, the three spatial dimensions of the nanoparticle being between 1 nm and 100 nm.

The term “metallic nanostructure(s),” as used herein, refers to nanostructures made of or comprising metal, for example, silver, gold, cadmium, germanium, lead, or compounds or alloys containing the above-mentioned metals. These metallic nanostructures include metallic nanoshells, as described herein. The metallic nanostructures can be fabricated using electron-beam lithography, focused ion-beam lithography, nanosphere lithography, dip-pen nanolithography, soft lithography, chemical, electrochemical or photochemical means, or the like. The metallic nanostructures can have different sizes and different shapes, for example, spherical, cubical, tetrahedral or octahedral. The absorption and scattering coefficients of the metallic nanostructures may be altered by changing the shape and size of the nanostructures. It is preferred that at least about 90% of metallic nanostructures in a given mixture be of the same shape.

It is known that certain metallic nanostructures exhibit surface plasmon resonance upon interaction with light. Typically, gold, silver, copper, titanium or chromium nanostructures exhibit such resonance, i.e., resonance of the surface electromagnetic waves when free electrons interact with light. The collective oscillation of free electrons in the metal, also referred to as surface plasmons, facilitates transmission of photons of a certain wavelength range.

The size and/or shape of the nanostructures can determine the surface plasmon resonance. Metallic nanostructures of the size ranging from 10 nm to 50 nm produce a strong and sharp surface plasmon resonance in response to light in the wavelength range of about 350 nm to about 700 nm. For example, silver nanostructures of about 10 nm in diameter have a plasmon resonance at about 355 nm while silver nanostructures of about 60 nm in diameter have a plasmon resonance at about 475 nm, the wavelength of blue light. Gold nanostructures having a diameter of about 10 nm, for example, have a plasmon resonance centered at about 520 nm. Increasing the size of the gold nanostructures shifts the surface plasmon resonance closer to the wavelength of red light, for example, gold nanostructures having a diameter of about 50 nm have a plasmon resonance centered at about 620 nm.

The term “metallic nanoshell(s),” as used herein, refers to nanoparticles consisting of a nonconducting inner layer, e.g., a dielectric core, surrounded by an electrically conducting material, e.g., a metallic shell. For example, the dielectric core may be formed of silicon dioxide, titanium dioxide, polystyrene, gold sulfide, and polymethyl methacrylate and the metallic shell may be formed of gold, silver, copper, platinum, palladium, or lead. The surface plasmon resonance in metallic nanoshells is determined by the ratio of the radius of the dielectric core to the thickness of the metallic shell.

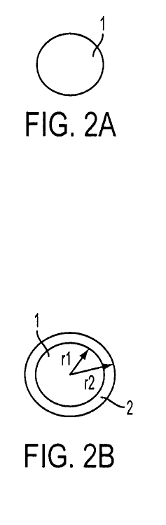

The metallic nanoshells can be prepared by first fabricating a dielectric core 1, such as illustrated in FIG. 2A. For example, 2.2 ml of tetraethyl orthosilicate can be added to a solution containing 50 ml of ethanol and 4 ml of NH₄OH, and stirred for about 8 hours or longer. Silica particles of 20 nm to 500 nm in diameter can be formed by varying the concentration of tetraethyl orthosilicate, NH₄OH or ethanol. A metallic shell 2, such as illustrated in FIG. 2B, is then formed around the dielectric core 1 using a reduction reaction. For example, gold shells of about 1 to 3 nm can be formed around the silica particles by immersing the silica particles in a gold colloid bath. The surface plasmon resonance of the metallic nanoshells is determined by the ratio of the radius of the dielectric core r₁ to the thickness (r₂−r₁) of the metallic shell. For example, core 1 to shell 2 ratio of 60 to 20 for a gold shell has a surface plasmon reasonance of about 740 nm. Although in the embodiment shown in FIGS. 2A-2B the metallic nanoshell is shown to be spherical in shape, it should be understood that the metallic nanoshells can be cubical, cylindrical, hemispherical, or any other shape.

The term “color filter material(s),” as used herein, refers to materials formed by embedding metallic nanostructures into glasses, epoxies, polymers or the like, or by providing the nanostructures as part of such glass, epoxy, polymer, using methods known in the art. Such color filter materials can allow light of a certain wavelength to pass through, based on the shape and size of the metallic nanostructures.

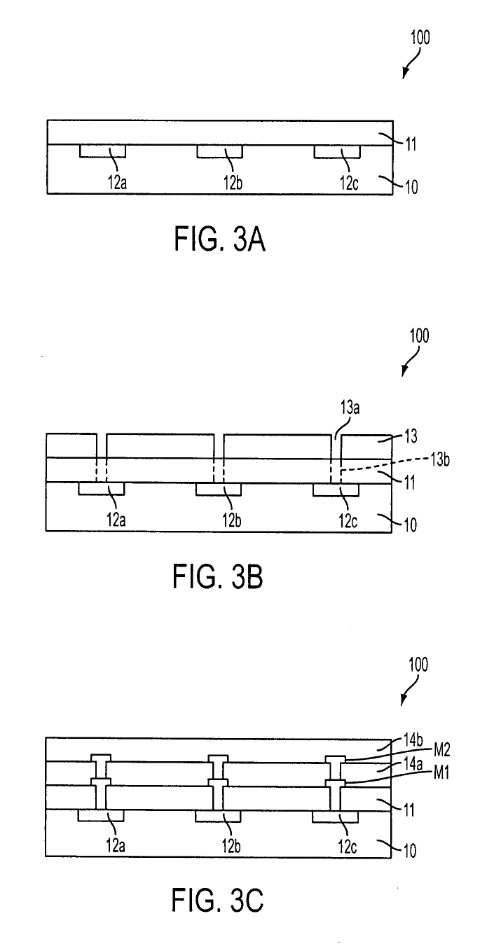

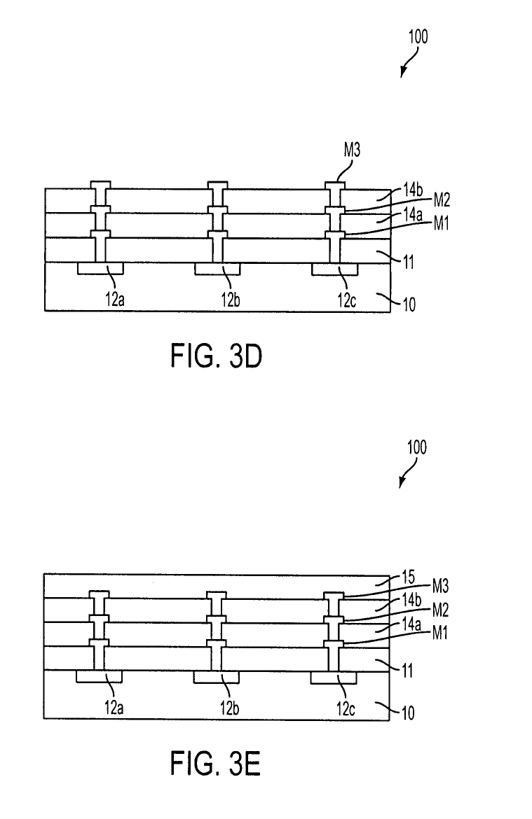

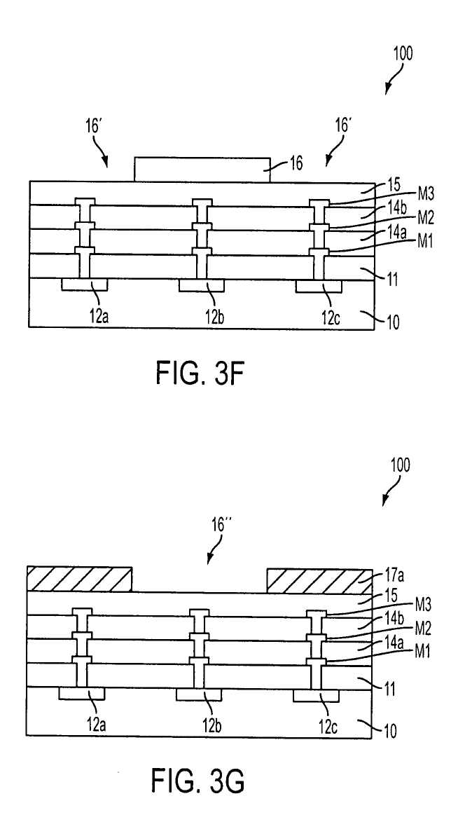

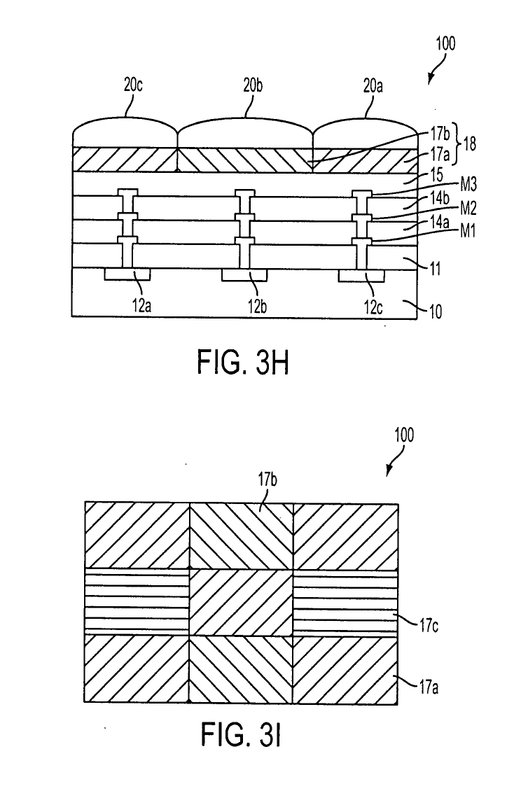

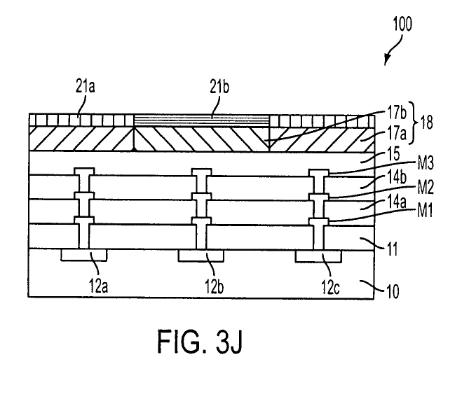

FIG. 3A shows a portion of a pixel array 100 comprising pixels 12a, 12b, 12c at an early stage of fabrication. The pixels 12a, 12b, 12c, each having photosensitive elements, are formed supported by a semiconductor substrate 10. The photosensitive element can be any photon-to-charge converting device, such as a photogate, photoconductor or photodiode. A transparent dielectric material 11 is provided over the substrate 10 and pixels 12, 12b, 12c, the transparent dielectric material 11 preferably being a conformally deposited layer that may be planarized to provide a substantially smooth top surface. The transparent dielectric material 11 should be a material that allows light to pass through to the photosensitive element of the pixels, e.g., 12a, 12b, 12c, such as, for example, silicon dioxide, boro-silicate glass (BSG), phospho-silicate glass (PSG), or boro-phospho-silicate glass (BPSG). The transparent dielectric material 11 may be formed by known deposition methods, such as, for example, sputtering, chemical vapor deposition (CVD), plasma enhanced CVD (PECVD), or physical vapor deposition (PVD). The transparent dielectric material 11 is preferably about 300 Å to about 6000 Å thick.

Referring to FIG. 3B, the transparent dielectric material 11 is etched to provide contact holes 13b within which to provide contacts to electrical elements within each of the pixels 12a, 12b, 12c. The etching can be performed using typical photolithographic techniques using a masking material 13 and associated openings 13a. The openings 13b can then be filled with a conductive material, for example, tungsten, which is then planarized down to the top surface of the transparent dielectric material 11, for example, by chemical mechanical planarization (CMP).

Next, a conductive material can be deposited over the transparent dielectric material 11 and openings 13b and excess conductive material is removed by dry etching to form a first conductive interconnect trace M1, which can be in electrical contact with the contacts. An interlevel dielectric (ILD) material 14a can be formed over the transparent dielectric material 11 and the first conductive interconnect trace M1. The interlevel dielectric material 14a should have similar light transmitting and insulating properties as the transparent dielectric material 11. The interlevel dielectric material 14a can be between about 300 Å to 6000 Å thick. The interlevel dielectric material 14a can be etched to provide contact holes, for electrical by connecting with the first conductive interconnect trace M1. A conductive material can be deposited over the interlevel dielectric material 14a and excess conductive material is removed by dry etching to form the second conductive interconnect trace M2. An interlevel dielectric (ILD) material 14b is then formed over the interlevel dielectric material 14a and the second conductive interconnect trace M2. Additionally, an interlevel dielectric material 14b and a third conductive interconnect trace M3 can also be provided in the same way.

A passivation material 15 can then be formed over the interlevel dielectric material 14b and the third conductive interconnect trace M3, as illustrated in FIG. 3E. The passivation material 15 is preferably between about 1000 Å to 6000 Å thick and can be planarized by chemical mechanical polishing. The passivation layer 15 is typically formed of Tetraethyl Orthosilicate, Si(OC₂H₅)₄ (TEOS).

Referring to FIG. 3F, openings 16′ are formed using a masking material 16. Next, a first color filter material 17a comprising nanostructures, formed using the methods described herein, is deposited, as illustrated in FIG. 3G, on the passivation layer 15 to substantially fill the openings 16′ (FIG. 3F). The first color filter material 17a may be such that it filters incident light and allows only light within a wavelength range of a given color, for example, green, to pass through onto the pixels 12a, 12c. For example, the first color filter material 17a may be formed of gold nanostructures having a diameter of about 10 nm embedded in glass, or some other transparent substance, the first color filter material 17a being capable of filtering light other than wavelength of about 520 nm, which is transmitted to the photosensitive element. The first color filter material 17a may be deposited by deposition methods, such as, for example, chemical vapor deposition or sputtering. The first color filter material 17a may be the only color filter provided, or additional color filters may be added, as described below.

Referring to FIG. 3H, a second color filter material 17b is deposited on the passivation material 15 to substantially fill the openings 16″ (FIG. 3G). The second color filter material 17b may be such that it filters incident light and allows only light within a wavelength range of a given color, for example, red, to pass through onto the pixel 12b. For example, the second color filter material 17b may be formed of gold nanostructures having a diameter of about 50 nm embedded in glass, the second color filter material 17b being capable of filtering light other than wavelength of about 620 nm. The second color filter material 17b may be deposited by deposition methods such as chemical vapor deposition or sputtering.

A third color filter material 17c (FIG. 3I) is deposited on the passivation material 15 to substantially fill the openings (not shown) between two consecutive openings 16′. The third color filter material 17c (FIG. 3I) may be such that it filters incident light and allows only light within a wavelength range of a given color, for example, blue, to pass through onto the corresponding pixel. For example, the third color filter material 17c may be formed of silver nanostructures having a diameter of about 60 nm embedded in glass, the third color filter material 17c being capable of filtering light other than wavelength of about 475 nm. The third color filter material 17c (FIG. 3I) may be deposited by deposition methods such as chemical vapor deposition or sputtering.

In another embodiment, the first color filter material 17a may be formed of gold nanostructures having a diameter of about 50 nm, the second color filter material 17b may be formed of gold nanoshells having a diameter of about 50 nm, thickness of about 2-5 mm and having no core, and the third color filter material 17c may be formed of gold nanoshells having a diameter of about 9.8 nm, thickness of about 1-2 nm and with a hematite core or gold nanoshells having a diameter of about 100 nm, thickness of about 5-15 nm with a SiO₂ core. The first color filter material 17a is a blue-pass filter, the second color filter material 17b is a red-pass filter, and the third color filter material 17c is a green-pass filter.

The first, second and third color filter materials 17a, 17b, 17c are used to form a color filter pattern, including but not limited to a Bayer pattern. Subsequent to their deposition, the first, second, and third color filter materials 17a, 17b, 17c are planarized using an abrasive planarization etching technique, such as, for example, chemical mechanical planarization (CMP). The first color filter material 17a, the second color filter material 17b, and the third color filter material 17c are collectively referred to herein as the color filter array 18.

Subsequent to forming the color filter array 18, conventional microlenses 20a, 20b, 20c can be fabricated over the color filter array 18. The microlenses 20a, 20b, 20c can be produced, for example, by depositing and patterning a lens material and then baking to produce a suitable lens shape over each of the photosensors 12a, 12b, 12c. Suitable materials for the lens material include, for example, phenolic resin-based materials, and other materials that have high transmissivity, for example, greater than 90 percent, across the visible spectrum of light, i.e., 380-780 nm, and are resistant to environmental effects (e.g., humidity).

Referring to FIG. 3J, the pixel array 100 comprising pixels 12a, 12b, 12c can also be fabricated by forming transparent structures 21a, 21b over the color filter array 18. Incident light is focused by the transparent structures 21a, 21b through the color filter array 18 to the photosensitive element of the pixels 12a, 12b, 12c.

Optionally, a spacer material 19 can be formed between the color filter array 18 and the microlenses 20a, 20b, 20c. The spacer material 19 may be formed of nitride or polyimide. The spacer material 19 is preferably in the range of 500 Å to 2000 Å thick.

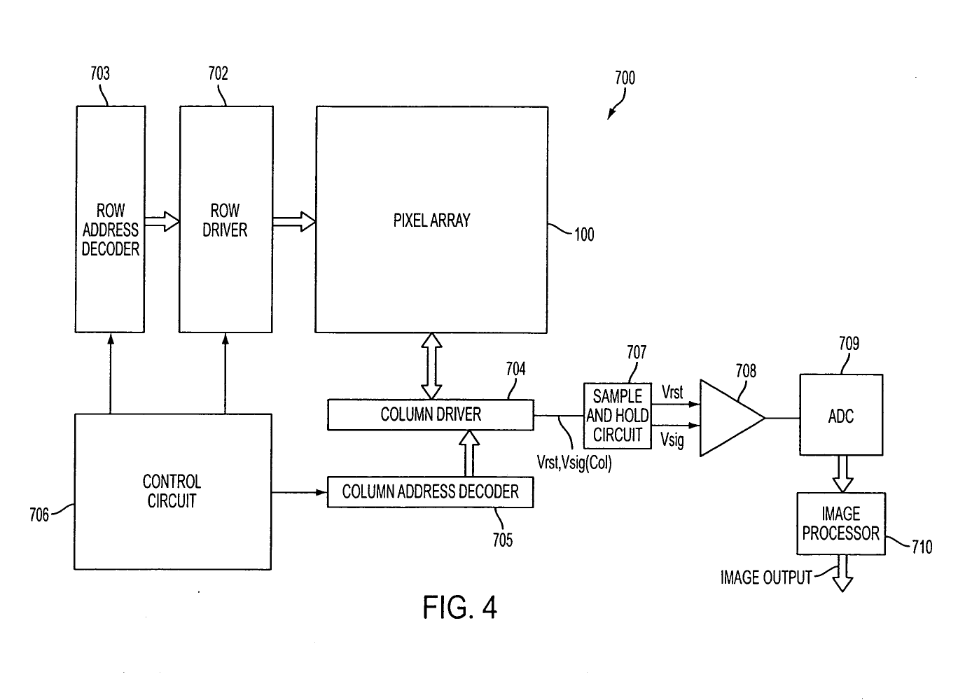

A pixel array 100 employing a color filter array constructed in accordance with the embodiments described herein may be used in an imaging device 700 of the type depicted in FIG. 4. FIG. 4 illustrates a block diagram of a CMOS imager 700 having a pixel array 100, constructed as described above with reference to FIGS. 3A-3J. Pixel array 100 comprises a plurality of pixels 12a, 12b, 12c (FIGS. 3A-3J) arranged in a predetermined number of columns and rows. The pixels 12a, 12b, 12c (FIGS. 3A-3J) of each row in array 100 are all turned on at the same time by a row select line, and the pixels of each column are selectively output by respective column select lines. A plurality of row and column lines are provided for the entire array 100. The row lines are selectively activated in sequence by the row driver 702 in response to row address decoder 703 and the column select lines are selectively activated in sequence for each row activated by the column driver 704 in response to column address decoder 705. Thus, a row and column address is provided for each pixel. The CMOS imager 700 is operated by the control circuit 706, which controls address decoders 703, 705 for selecting the appropriate row and column lines for pixel readout, and row and column driver circuitry 702, 704, which apply driving voltage to the drive transistors of the selected row and column lines.

The pixel output signals typically include a pixel reset signal, Vrst, taken off the floating diffusion node when it is reset and a pixel image signal, Vsig, which is taken off the floating diffusion node after charges generated by an image are transferred to it. The Vrst and Vsig signals are read by a sample and hold circuit 707 and are subtracted by a differential amplifier 708 that produces a differential signal (Vrst−Vsig) for each pixel, which represents the amount of light impinging on the pixels. This difference signal is digitized by an analog to digital converter 709. The digitized pixel signals are then fed to an image processor 710 to form and output a digital image. The digitizing and image processing can be performed on or off the chip containing the pixel array 100.

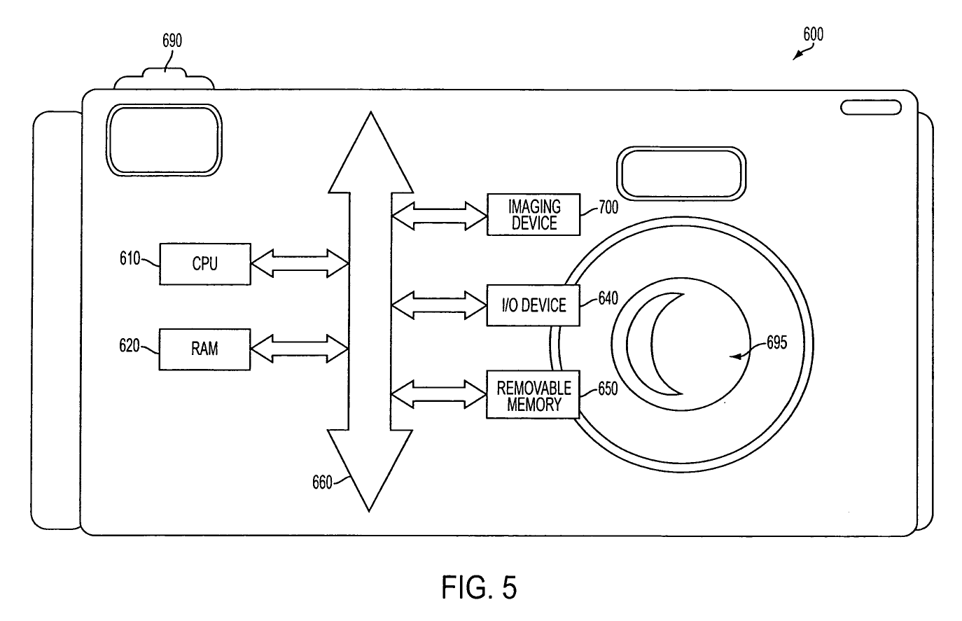

FIG. 5 shows an image processor system 600, for example, a still or video digital camera system, which includes an imaging device 700, constructed as described above with reference to FIGS. 3A-3J. The imaging device 700 may receive control or other data from system 600 and may provide image data to the system. System 600 includes a processor having a central processing unit (CPU) 610 that communicates with various devices over a bus 660. For a camera, CPU 610 controls various camera functions. Some of the devices connected to the bus 660 provide communication into and out of the system 600; one or more input/output (I/O) devices 640 and imaging device 700 are such communication devices. Other devices connected to the bus 660 provide memory, illustratively including a random access memory (RAM) 620, and one or more peripheral memory devices such as a removable memory drive 650. A lens 695 is used to allow an image to be focused onto the imaging device 700 when e.g., a shutter release button 690 is depressed. The imaging device 700 may be coupled to the CPU for image processing or other image handling operations. Non-limiting examples of processor systems, other than a camera system, which may employ the imaging device 700, include, without limitation, computer systems, camera systems, scanners, machine vision systems, vehicle navigation systems, video and cellular telephones, surveillance systems, auto focus systems, star tracker systems, motion detection systems, image stabilization systems, and others.

While various embodiments have been described above, it should be understood that they have been presented by way of example, and not limitation. It will be apparent to persons skilled in the relevant art that various changes in form and detail can be made without departing from the spirit and scope of the invention. Accordingly, the invention is not limited by the foregoing description, but is limited only by the scope of the appended claims.

What is claimed as new and desired to be protected by Letters Patent of the United States is:

1. An image sensor device comprising:
an array of pixels comprising photosensors; and
a color filter formed over the pixels and comprising metallic nanostructures having wavelength-respective passing properties.

2. The device of claim 1, wherein the color filter allows only light corresponding to a single color to pass to the photosensors.

3. The device of claim 1, wherein the color filter comprises an array of first filter regions, second filter regions, and third filter regions,
wherein the first, second and third filter regions respectively comprise first, second and third metallic nanostructures and each allows only respective wavelengths of light to pass to the photosensors.

4. The device of claim 3, wherein the metallic nanostructures comprise a material comprising at least one of gold, silver, and germanium.

5. The device of claim 3, wherein the plurality of filter regions are arranged in a Bayer color filter pattern.

6. The device of claim 3, wherein the first metallic nanostructures are gold nanostructures having a diameter of about 10 nm, and the second metallic nanostructures are gold nanostructures having a diameter of about 50 nm.

7. The device of claim 3, wherein the first metallic nanostructures are gold, coreless nanoshells having a diameter of about 50 nm, the second metallic nanostructures are gold nanostructures having a diameter of about 50 nm, and the third metallic nanostructures are gold nanoshells having a diameter of about 9.8 nm with a hematite core.

8. The device of claim 3, wherein the first, second and third filter regions allow red, blue and green light, respectively, to pass through to the photosensors.

9. An imager comprising:
an array of pixels; and
a color filter formed on the pixels, the color filter comprising a plurality of red filter regions, a plurality of blue filter regions, and a plurality of green filter regions, the plurality of red, blue and green filter regions being arranged in a color filter pattern and being formed of respective color filter materials comprising respective metallic nanostructures.

10. The imager of claim 9, wherein the respective metallic nanostructures are supported by a material comprising glass, the respective metallic nanostructures having sizes and shapes corresponding to a surface plasmon resonance of wavelengths of red, blue and green light, respectively.

11. The imager of claim 10, wherein the metallic nanostructures comprise a material comprising at least one of gold, silver, and germanium.

12. The imager of claim 10, wherein at least one of the respective metallic nanostructures comprises gold nanostructures having a diameter of about 10 nm.

13. The imager of claim 10, wherein at least one of the respective metallic nanostructures comprises silver nanostructures having a diameter of about 60 nm.

14. The imager of claim 10, wherein at least one of the respective metallic nanostructures comprises gold nanostructures having a diameter of about 50 nm.

15. The imager of claim 9, wherein the color filter pattern is a Bayer pattern.

16. The imager of claim 9, further comprising a plurality of insulating layers, at least one passivation layer between the pixels and the color filter, and a plurality of lenses over the color filter and in alignment with the filter regions.

17. The imager of claim 9, wherein the respective metallic nanostructures are respective metallic nanoshells.

18. The imager of claim 17, wherein the respective metallic nanoshells comprise a dielectric core and a metallic shell, the metallic shell surrounding the dielectric core.

19. The imager of claim 18, wherein the dielectric core comprises a material comprising silicon dioxide, titanium dioxide, gold sulfide, and polymethyl methacrylate.

20. The imager of claim 18, wherein the metallic shell comprises a material comprising gold, silver, copper, and platinum.

21. A method of forming an image sensor device, comprising:
forming a plurality of pixels;
forming a color filter over the plurality of pixels, the color filter comprising metallic nanostructures having a light wavelength passing property.

22. The method of claim 21, further comprising forming a first, second and third color filter regions of a first, second and third color filter materials, respectively.

23. The method of claim 22, wherein the first, second and third color filter materials filter light other than red, blue and green light, respectively.

24. A method of filtering light to an imager device, comprising:
providing a pixel array; and
passing light of a predetermined wavelength range to the pixel array using surface plasmon resonance in nanostructures positioned between a light source and the pixel array.

25. The method of claim 24, wherein the nanostructures are metallic nanoshells.

26. The method of claim 25, wherein the metallic nanoshells comprise a dielectric core and a metallic shell, the metallic shell surrounding the dielectric core.

27. The method of claim 26, wherein the dielectric core comprises a material comprising silicon dioxide, titanium dioxide, gold sulfide, and polymethyl methacrylate.

28. The method of claim 26, wherein the metallic shell comprises a material comprising gold, silver, copper, and platinum.
